(19) United States
(12) Patent Application Publication
(10) Pub. No.: US 2008/0101233 A1
(43) Pub. Date: May 1, 2008

(54) Method and apparatus for load balancing internet traffic

(75) Inventors: Weiguang Shi, San Diego, CA (US); Michael H. MacGregor, Edmonton (CA); Pawel Gburzynski, Edmonton (CA)

Correspondence Address: THELEN REID BROWN RAYSMAN & STEINER LLP, P. O. BOX 640640, SAN JOSE, CA, 95164-0640, US

(73) Assignee: The Governors of the University of Alberta

(21) Appl. No.: 11/586,887

(22) Filed: Oct. 25, 2006

(51) Int. Cl. G06F 19/00

(52) U.S. Cl. 370/235

(57) ABSTRACT

A load balancer is provided wherein packets are transmitted to a burst distributor and a hash splitter. The burst distributor consults a flow table to make a determination as to which forwarding engine will receive the packet, and if the flow table is full, returns an invalid forwarding engine. A selector sends the packet to the forwarding engine returned by the burst distributor, unless the burst distributor returns an invalid forwarding engine, in which case the selector sends the packet to the forwarding engine selected by the hash splitter. The system is scalable by adding additional burst distributors and using a hash splitter to determine which burst distributor receives a packet.

### FIELD OF THE INVENTION

This invention relates to computer communications networks, and more particularly to load balancing traffic over communications networks.

### BACKGROUND OF THE INVENTION

Network traffic has been steadily increasing with the widespread transmission of data, including audio and video files over such networks. The largest and most important of these networks is the global network of computers, known as the Internet, which uses routers to organize and direct traffic (i.e. packets sent from one computer in the network to another). Parallel forwarding has been used to address the performance challenges faced by such Internet routers.

Packet level parallel forwarding allows a router to divide its workload on a packet-by-packet basis among multiple forwarding engines (FEs) for key forwarding operations, e.g., route lookup. FIG. 1 displays a prior art multi-processor forwarding system wherein each FE 20 obtains its input from a corresponding input queue 30. Scheduler 40 distributes the workload by deciding which input queue 30 a packet should be delivered to. Even though multi-FE forwarding is a relatively simple application of parallelism, it does have its own problems, in particular, maintaining sequential delivery of packets, which is one of the hard invariants imposed (or assumed) on forwarding by the receiving systems, and which conflicts with performance goals, e.g., cache hit rates and load balancing. Bennett, et al. in “Packet reordering is not pathological network behavior” (IEEE/ACM Trans. Netw., 7(6):789-798, 1999) explains the difficult problem of preventing packet reordering in a parallel forwarding environment and its negative effects on TCP communications. Bennett et al. outlines possible solutions and points out that at the IP layer, hashing as a load-distributing method can be used to preserve packet orders within individual flows in ASICbased parallel forwarding systems; but, on the other hand, underutilization of FE's can occur with simple hashing.

The problem of packet reordering received enormous attention in late 2000 when the OC-192 interface released by Juniper Networks, was found to reorder packets when system load was high. A debate ensued between vendors as to whether packet reordering in the interface was a bug. Laor and Gendel, in “The effect of packet reordering in a backbone link on application throughput” (IEEE Network, 16(5):28-36, 2002), considered the packet reordering problem in a lab environment and predicted the increased use parallel processing in IP forwarding. Laor and Gendel advocated the use of transport layer mechanisms, for example TCP SACK and D-SACK, that deal with packet reordering to a limited extent, and pointed out that load balancing in a router should be done according to source-destination-pairs (and not per packet) to preserve the intended order.

W. Shi, M. H. MacGregor, and P. Gburzynski in “Load balancing for parallel forwarding” (IEEE/ACM Transactions on Networking, 13(4), 2005) discloses a Zipf-like distribution to characterize packet flow popularity and demonstrates that for certain Zipf-like functions (that are unlikely to occur in real-life scenarios), hashing on flows does not balance workload of the FEs. Shi et al. disclose a load-balancer that identifies and spreads dominating packet flows over the FEs. J.-Y. Jo, Y. Kim, H. J. Chao, and. F. Merat in “Internet traffic load balancing using dynamic hashing with flow volumes” (Internet Performance and Control of Network Systems III at SPIE ITCOM 2002, pages 154-165, Boston, Mass., USA, July 2002), discloses a similar design that identifies and schedules dominant packet flows to achieve load balance. The results demonstrate that achieving load balancing without splitting individual flows over multiple FEs is not always possible. Consequently, preventing packet reordering is incompatible with maximizing the performance of a parallel router.

Generally, per-packet scheduling schemes such as roundrobin do not preserve order and result in poor temporal locality in the workload of the individual FEs. On the other hand, the extent of load-balancing accomplished by the per-flow scheduling methods, such as hashing on IP header fields, is subjective based on the Internet traffic characteristics. Another option is to use packet bursts as the scheduled entities, which is a compromise between the two extremes, as load balancing burst size (as the number of packets) distribution can be less skewed than flow size distribution. This makes bursts a much better scheduling unit when attempting to achieve load balancing.

Furthermore, using bursts keeps packet order preservation within flows. The lulls between packet bursts within a flow are long enough to guarantee sequential delivery of packets even if the bursts are handled by different FE's.

Also temporal locality, defined as the phenomenon that the possibility of referencing an object is positively correlated with its reference recency, can be preserved when scheduling a burst of packets onto the same FE.

In this document of the “flow” of a packet means the transport-layer “stream” to which the packet belongs. For example, the flow of a packet can be identified by the fourtuple <source host, source port, destination host, destination port>, which is matched to the corresponding fields of the packet to determine the packet's flow membership.

It is well known that TCP carries over 90% of the Internet's traffic. For forwarding system design, it is therefore important to understand the intrinsic qualities of TCP transactions. Bursts from large TCP flows are the major source of the overall bursty Internet traffic. There are several common causes of source-level IP traffic bursts, one for UDP and eight for TCP flows. The latter include: slow starts, loss recovery with fast retransmits, unused congestion window increases, bursty applications, cumulative or lost ACKs, and others. Most of these causes are due to anomalies or auxiliary mechanisms in TCP and Internet applications (on the other hand, TCP's window-based congestion control itself lends to bursty traffic and therefore, even without the other causes, as long as a TCP flow cannot fill the pipe between the sender and the receiver, bursts will occur).

A micro-congestion episode is defined as a period of time in which packets experience increased delays due to increased volume of traffic on a link. Micro-congestions are observed at small time scales, e.g., milliseconds, where high throughput contributes to larger delays. Therefore, link utilization calculated through statistics gathered at large intervals can be a poor indicator of delay and congestion. High throughput during microcongestion may be due to back-to-back TCP packets in cases where there is no cross-traffic and thus minimize delay.

W. Shi, M. H. MacGregor, and P. Gburzynski, in “A novel load balancer for multiprocessor routers” (In SPECTS '04, pages 671-679, San Jose, Calif., USA, July 2004), model IP destination address frequency using a Zipf-like distribution and demonstrate that under a workload whose Zipf parameter is larger than 1.0, hashing cannot balance the load on its own, even in the long run. Shi et al. discloses a scheme that capitalizes on identifying and distributing dominating flows in the input traffic for a parallel forwarder. To identify dominating flows, the scheduler employs a flow classifier that filters contiguous and nonoverlapping windows of packets and uses the largest flows identified in one window to predict the dominating flows in the next.

However, there are limitations with the above solution. First, the solution does not work well with finer flow definitions, e.g., the five-tuple (source IP address, source port number, destination address, destination port number, protocol). Second, the flow classifier is placed on the forwarding path for the aggregate traffic and therefore is not scalable as the system's parallelism increases. Third, with large windows to predict long-term dominating flows, the solution may not be responsive to short-term workload surges, observed as packet bursts. This is because of the precision of the prediction made by the windowing scheme. Dynamically adjusting window size might be effective to some extent, but does not scale for a load-balancing system, and processes every single packet.

### BRIEF SUMMARY OF THE INVENTION

The solution according to the invention schedules packet bursts to achieve multi-FE load balancing. The dominant internet transport protocol, TCP, is inherently bursty due to its window-based congestion control mechanisms. Packets between two communicating parties tend to travel in flows with relatively large gaps instead of spreading out evenly over time. The time scales for micro-congestion are preferably below 100 ms. Queuing delays on a well-provisioned network should only happen during micro-congestions.

A load balancer is provided, including a burst distributor; a hash splitter; a selector, and a plurality of forwarding engines; wherein the burst distributor receives a packet and selects one of the plurality of forwarding engines to transmit the packet, or selects an invalid forwarding engine to transmit the packet; said hash splitter also receives the packet; said hash splitter selects one of the plurality of forwarding engines to transmit the packet; and the selector receives the packet from the burst distributor and the hash splitter, and sends the packet to the forwarding engine selected by the burst distributor if the forwarding engine selected by the burst distributor is valid; and if the forwarding engine selected by the burst distributor is invalid, sending the packet to the forwarding engine selected by the hash splitter.

The burst distributor may include a flow table, and on receipt of a packet, creates an entry in the flow table associated with the packet. The entry in the flow table for the packet includes a flow associated with the packet.

The burst distributor, on transmitting the packet to the selector, tags the packet with information regarding the flow associated with the packet. The forwarding engine selected by the selector, on transmitting the packet to a destination associated with the packet, transmits a message to the burst distributor. On receipt of the message from the forwarding engine selected by the selector, the burst distributor deletes the packet from the flow table.

The load balancer of claim 1 may include a second burst distributor, and a second hash splitter, wherein the second hash splitter determines which of the first and the second burst distributors receives the packet.

A method of selecting a forwarding engine from a plurality of forwarding engines is provided, including: (a) providing a burst distributor having a flow table, the flow table having a plurality of records of packets, each of the packets associated with a flow, each of the flows associated with a forwarding engine; (b) the burst distributor receiving a first packet, the first packet associated with a flow; (c) searching the flow table for a second packet associated with the flow; (d) if a second packet is located in the table, returning the forwarding engine associated with the flow that is associated with the second packet, to a selector; (e) if the second packet is not located, determining if the flow table is full; (f) if the flow table is not full, determining a forwarding engine within the plurality of forwarding engines having a minimum number of packets; and returning the forwarding engine having a minimum number of packets to the selector; and (g) if the flow table is full, returning an invalid forwarding engine to the selector.

### BRIEF DESCRIPTION OF THE DRAWINGS

FIG. 1 is a block diagram of a prior art multi-processor packet forwarding system;

FIG. 2 is a chart showing the popularity distribution for packet flows of different destinations;

FIG. 3 is a second chart showing the popularity distributions for packet flows of different destinations;

FIG. 4 is a chart showing packet bursts within a flow;

FIG. 5 is a chart showing the probability density of the number of flows in a system;

FIG. 6a and 6b are charts showing the maximum and median of N_{fit} as functions of N_{fe} and ρ;

FIG. 7 is a chart showing a Q-Q plot against normal for 1000 observations;

FIG. 8 is a block diagram showing a load balancer according to the invention;

FIG. 9 is a flow chart showing the steps of using the flow table to make a choice of forwarding engine according to the invention;

FIGS. 10a and 10b are charts showing the effectiveness of burst-level load balancing;

FIGS. 11a and 11b are charts showing the comparison between BLB and FLB schemas; and

FIG. 12 is a block diagram of a scalable burst-level load balancer according to the invention.

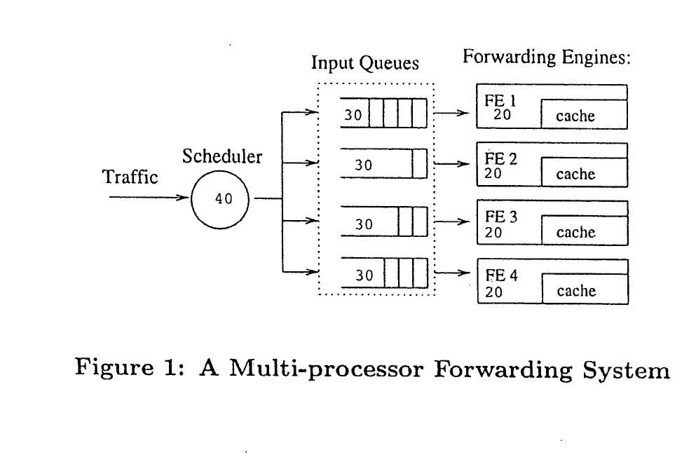

### DETAILED DESCRIPTION OF THE INVENTION

Experiments referred to in this document in support of the invention were conducted using IP traces from the Abilene-I and Abilene-III sets, available from the National Laboratory of Advanced Network Research (NLANR). These traces are the first collected over OC-48 and OC-192 links and serve to study backbone Internet traffic characteristics. Studies of the individual traces were conducted, each including 10 minutes worth of traffic. Traffic over short periods exhibit less variance in rates, therefore making the estimation of average utilization in simulations more reliable.

The trace most relied on in the experiments was the trace designated IPLSCLEV-20020814-103000-0 (herein “IPLS-CLEV”). This trace is the largest in the Abilene-I set, containing 47,729,751 packets. Analysis and simulations with several Abilene-III traces yielded similar results.

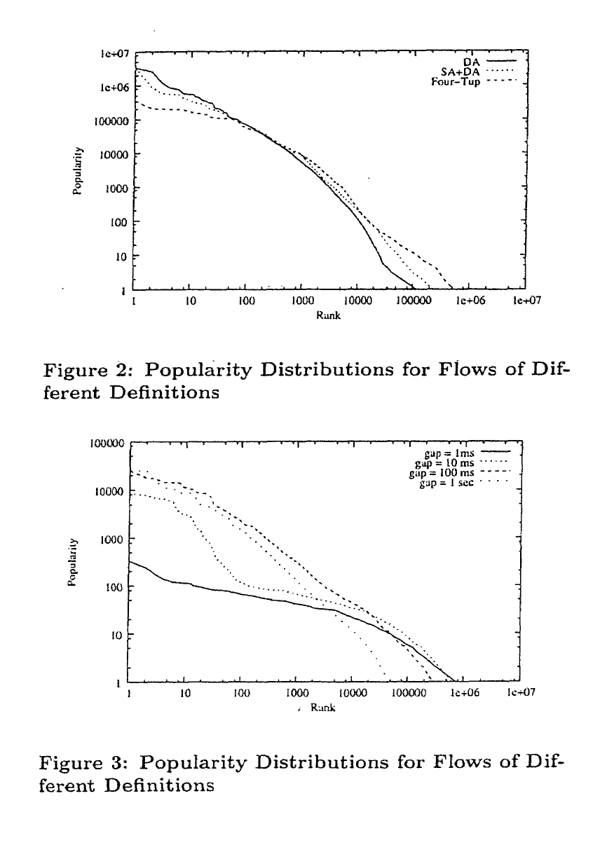

FIG. 2 displays the popularity distributions for different flow definitions: destination address (DA), source and destination address pair (SA+DA), and the fourtuple of source and destination addresses and source and destination ports (only for TCP/UDP) (Four-Tup). Flows of different granularity all exhibit highly skewed distributions, making load-balancing using hashing difficult.

Zipf's law states that the frequency of some event (P) as a function of its rank (R) often obeys the power-law function:

P(R)˜1/R^{a} Equation 1:

with the exponent a having a value close to 1. Fitting the empirical data with this distribution using the method described in L. Adamic and B. Huberman, “Zipf's law and the internet”. (Glottometrics 3, pages 143-150, 2002) yields a values of 1.00656 (for four-tuples), 1.1206 (for destinations), 1.1478 (for source-destinations), and 1.25719 (for sources).

FIG. 2 also shows that the finer the flow definitions, the less skewed the distributions. To find even less skewed flow distributions, finer-scale flows are observed in another dimension, i.e., time. In this case a recursive definition of a burst with a flow is used, i.e., if the inter-arrival time between the ith and the i+1th packets is less than a predefined timeout threshold, the two packets are considered to belong to the same burst. FIG. 3 displays the results of the popularity distributions of bursts identified using different inter-burst gap timeout values, ranging from 1 ms to 1 s.

Not surprisingly, the experiment showed that the larger the timeout value, the more skewed the distribution and the more dominant the several large bursts. In burst scheduling using pure hashing, large bursts can still be the major cause of short-term load-imbalance. On the other hand, the much more even burst popularity distributions (compared to flow size distributions) indicate that more traffic can be used to counter affect the imbalance caused by large bursts without causing reordering of packets.

In general, to achieve load balancing by setting small timeout values is not desirable for all purposes. Specifically, the router caches may be better utilized when adjacent bursts belonging to the same flow or larger bursts resulted from larger timeout values, are mapped to the same processors.

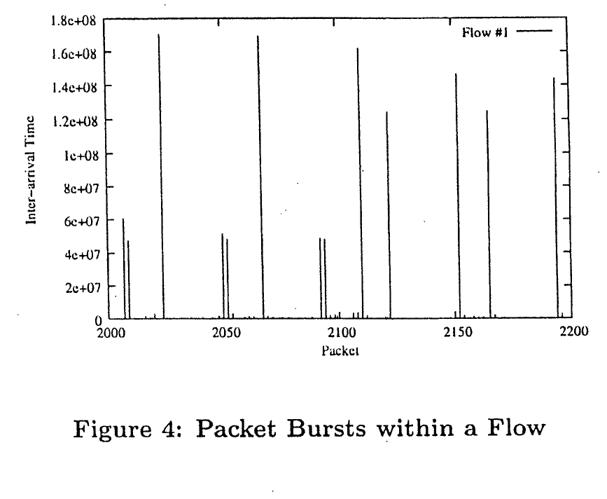

FIG. 4 shows the inter-arrival times of a portion of the largest TCP flow found in the IPLS-CLEV trace. In the IPLS-CLEV trace, TCP flows represent over 93% of the contents. The time unit seen on the Y axis is 2⁻³²th of a second. The transmission pattern of the TCP flow exhibits the typical packet train phenomenon: groups of packets with small inter-arrival times are divided by much larger inter-group gaps. Most relatively large tCP flows in the examined traces exhibit the similar pattern.

Considering the class of non-flow-based scheduling schemes, e.g., round-robin, least-loaded first, and various adaptive scheduling techniques, which can potentially misorder packets within the same flow, the next experiment considers “what are the conditions so that two adjacent packets from the same flow are not reordered by a parallel forwarding system?”

Let Pᵢ and Pⱼ where j=i+1 be two adjacent packets in a flow. The two packets arrive at a router at time tᵢ and tⱼ, respectively, and are appended to the queues of two FEs, FEᵢ and FEⱼ. Let Ti=tⱼ−tᵢ. Let the buffer size of each FE in an N-FE parallel forwarding system be L packets and the overall system utilization be ρ. Let the number of packets preceding Pᵢ and Pⱼ in their respective queues be Lᵢ and Lⱼ. As far as packet reordering is concerned, the extreme case scenario happens when, upon their arrival, Pᵢ is appended to the end of FEᵢ's queue since FEᵢ's queue is almost full and Pⱼ is placed at the front of FEⱼ's queue since FEⱼ's queue is empty. In other words, in this case Lᵢ=L and Lⱼ=0. This is when reordering is most likely to occur.

On the other hand, the following (sufficient but not necessary) condition guarantees that the two packets will not be reordered:

Lᵢ−Tᵢ*B/ρ/N<Lⱼ Equation 2:

where B is the physical bandwidth of the interface. This guarantee against reordering can also be expressed this way:

Tᵢ>(Lᵢ−Lⱼ)*ρ*N/B Equation 3:

To prevent the extreme case scenario described above, Tᵢ>L*ρ/B/N. If given that the total input buffer size BSZ is divided evenly among N FEs, then L=BSZ/N and the condition to prevent the extreme case can be expressed as:

Tᵢ>BSZ*ρ/B Equation 4:

As an example, assuming the average packet length is 1000 bytes, with BSZ=1000 pkts=1000*1000*8 bits=80 Mbits, ρ=1, and B=1 Gbps, then Tᵢ=8 ms, which is less than the minimum round trip delay time (RTT) seen on the Internet in several studies.

Equation 4 demonstrates that as BSZ increases, so does the lower bound of Tᵢ. This bound is important for embodiments of the invention wherein a fixed threshold for Tᵢ must be set. Also equation 4 shows that decreasing p reduces the lower bound for Tᵢ. It is also noteworthy that the aggregate bandwidth, B, plays a significant part in determining this bound for Tᵢ. Given a fixed BSZ and ρ, a small B, representing a slow link, increases the time a packet has to wait in a queue, that is, its sojourn time, and in turn increases the lower bound of Tᵢ.

Gaps between groups of packets may be large enough to allow shifting of a flow from one FE to another FE at the beginning of a group without causing packet reordering. To verify this idea, experiments were performed. The experiment calculated the number of “opportunities” wherein an incoming packet, and the flow of this packet, can be safely shifted to a different FE than the one the packet was currently mapped to with the condition that no packet reordering within the flow should result under the extreme case scenario. The implementation of this condition is simple, as when a packet arrives, a counter of opportunities was incremented by one whenever there was no packet from the same flow in the queue of the FE that the packet should be sent onto by default.

Assume that each FE in an N-FE system has one input queue for the incoming packets delivered to the FE to be processed on a first-in-first-out basis. Let P_{i,j} be the jth packet to be processed in the ith queue. Define ƒ: Ω→I as the mapping function implemented by a load balancer, where Ω is the flow identifier space (e.g., the set of fourtuples) and I={0, 1, . . . , N−1} is the set that contains the indices of the FE's. Therefore, packets from the flow ω(εΩ) will be forwarded to FE_{f(ω)}.

Given a current incoming packet with flow identifier ω, if

ω≠ID(P_{ƒ(ω)j}),0≦j≦L_{ƒ(ω)} Equation 5

where I D is a function that returns the flow identifier of a packet and Lᵢ is the current length of FEᵢ's input queue, then the packet, and therefore the flow, may be remapped onto a different FE than dictated by ƒ(ω) without any risk of packet reordering.

Note that this assessment of the opportunities for remapping is conservative in two aspects. First, situations exist where even when the queue of FE_{ƒ(ω)} contains packets with the same flow id ω, if they are to be processed earlier than the incoming packet regardless of the target FE the latter is re-mapped onto, packet ordering within flow ω is still preserved. For example, if the earlier packets are already in the front of their queue and will be processed soon, packet ordering will be preserved. Second, the experiments were carried out with a hashing (CRC32) function ƒ and no other scheduling schemes were used to mitigate any load imbalance. Specifically, packets were not dropped to simulate the limited input packet buffer space. Therefore, under high utilization, queues may grow large, reducing the number of remapping opportunities.

Experiments were conducted with an eight-FE system under different system utilizations ρ. Table 1 displays the results of such experiments. In addition, the total number of flows was 3,177,245 and the minimum and maximum numbers of packets distributed to the individual FEs were 5,363,829 and 6,363,633 respectively.

TABLE 1
Opportunities to Remap without Packet
Reordering in an Eight-FE System

| ρ | # Chances | # Chances per flow | # Chances per packet |
|---|---|---|---|
| 1.0 | 7,373,111 | 2.3205 | 0.1544 |
| 0.9 | 20,288,234 | 6.3854 | 0.4250 |
| 0.8 | 29,405,295 | 9.2549 | 0.6160 |
| 0.7 | 33,064,564 | 10.4066 | 0.6927 |
| 0.6 | 35,838,747 | 11.2798 | 0.7508 |
| 0.5 | 38,191,399 | 12.0202 | 0.8001 |
| 0.4 | 40,210,783 | 12.6558 | 0.8424 |

Table 1 shows that under the system utilization of 1.0, in the experiment, there were more than 7 million packets, which represent more than 15% of the total traffic, that need not to be sent to the FE dictated by the mapping function ƒ. Remapping these packets will not cause packet reordering and can be directed to the least loaded FE to help balancing load.

For a practical design according to the invention, it is useful to know the number of flows in transit (N_{fit}), i.e., flows that are currently in the forwarding system. The upper limit on this variable is the total size of the buffer space in packets. In practice, due to temporal locality (and assuming a non-trivial amount of buffer space), there are usually far less flows. In addition, the router's processing capabilities and dropping rules can also affect N_{fit}. The processing capabilities affect the queue length when the input buffer is not full, and the dropping rules may change the contents of the buffer by evicting packets when the buffer is filled to a specified threshold. In the experiments reported herein, dropping rules were ignored and unlimited buffer space was assumed.

Under the above assumptions, N_{fit} can be affected by the amount of parallelism, the scheduling policy, and the overall system utilization. In the experiments, the scheduling policy was assumed to be to shift the incoming flow to the FE with the minimum load, if no packet from this flow exist in the system. As noted above, this was a conservative approach, nonetheless, it permitted the experiments to determine characteristics and trends instead of implementing the best policy to affect the number of flows in transit.

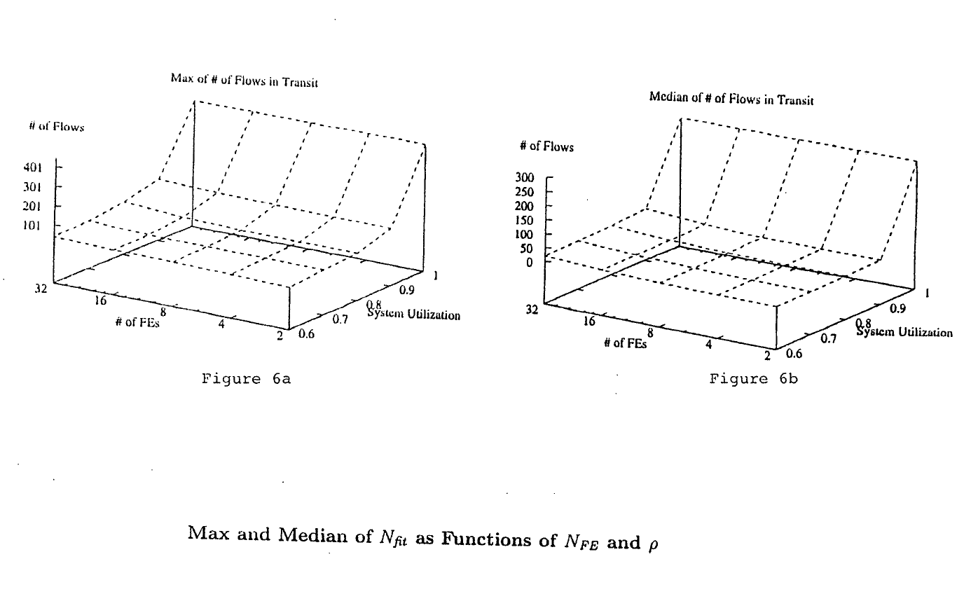

FIGS. 6a and 6b shows the results of the experiment under the above listed conditions. Under the burst-scheduling policy, the deciding factor for N_{fit} was system utilization. In particular, N_{fit} increases dramatically with ρ values of 0.9 and 1.0, regardless of the number of FEs. On the other hand, adding FEs does not necessarily increase N_{fit}, especially when ρ is less than 0.9.

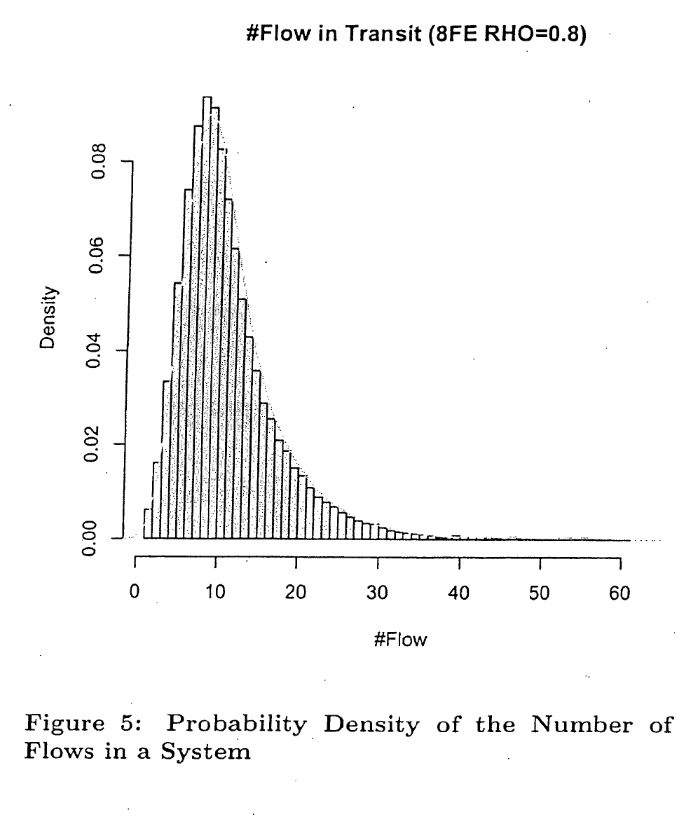

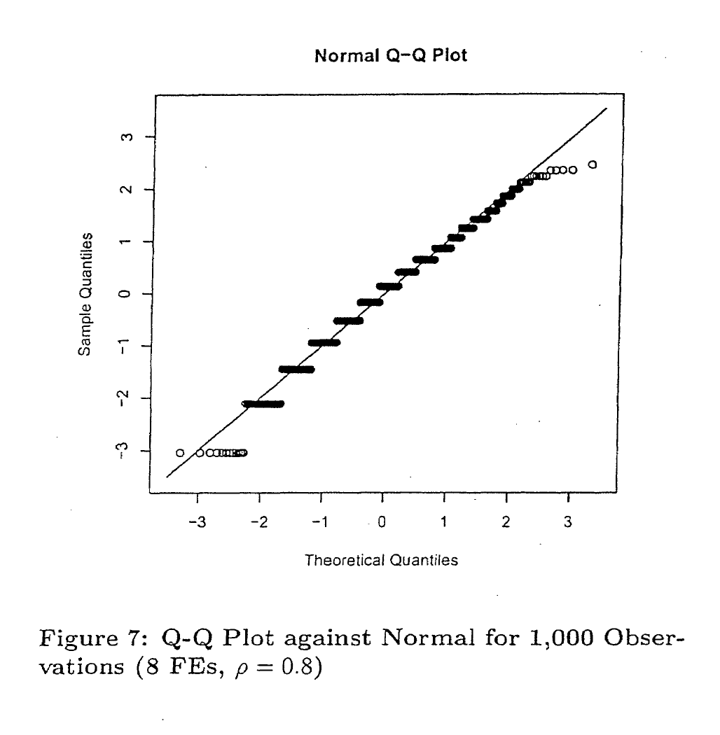

FIG. 5 shows the density of the number of flows observed in an eight-FE forwarding system with system utilization ρ=0.8. After normalizing the data, a sample of 1,000 consecutive observations (from observation 89,000 to 90,000) was used to generate the Q-Q plot shown in FIG. 7. The data can be reasonably well fitted by a Log-Normal distribution, although the right tail of the empirical distribution does not seem to be diminishing as fast. This observation, i.e., a Log-Normal body with a slightly fatter tail, is consistent when the parameters, e.g., the number of FEs and the system utilization, change.

### The Preferred Embodiment of a Load Balancer

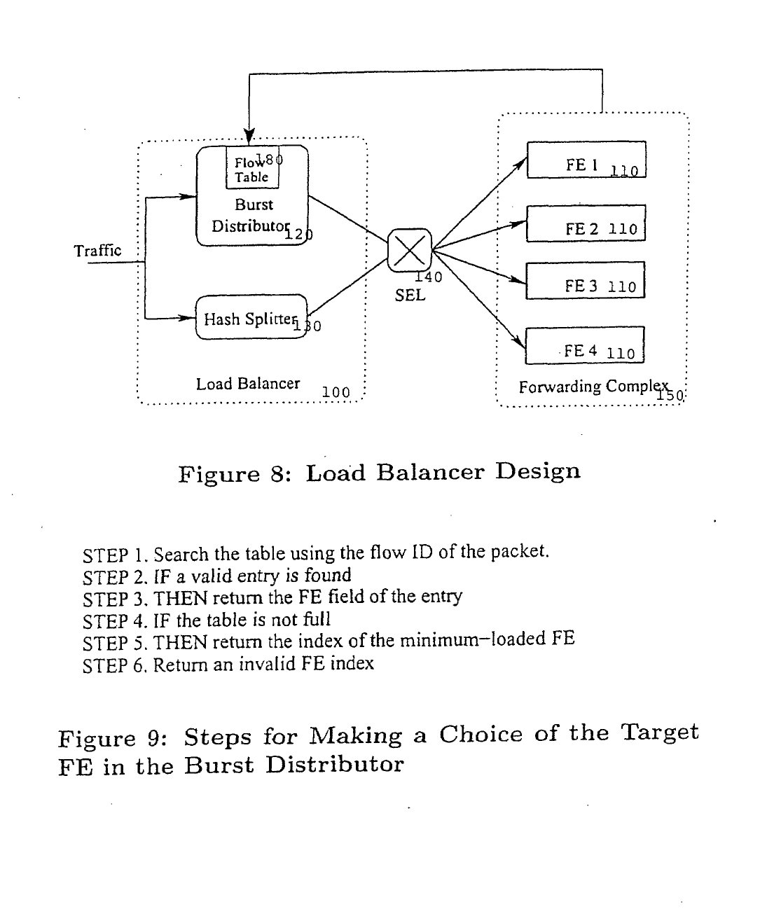

A preferred embodiment of a load balancer 100, according to the invention, is shown in FIG. 8. FIG. 8 displays a four FE 110 load balancer 100, although more or less FEs may be present. Load balancer 100 has two components: burst distributor (BD) 120; and hash splitter 130; working in parallel, which each receive traffic (as packets) from a network, such as the Internet. For an incoming packet, BD 120 may or may not choose a valid FE 110, but hash splitter 130 always computes a valid FE index using a hash function, e.g., CRC32, over the packet's flow identifier. When both BD 120 and hash splitter 130 arrive at decisions for a packet, selector 140 honors the decision of BD 120; otherwise, the packet is delivered to the FE 110 as calculated by hash splitter 130.

BD 120 accepts input from two sources, the incoming traffic, from the Internet or another network, and messages from forwarding complex 150. Forwarding complex 150 includes the FEs 110, as well as communications means to receive messages for the FEs 110 and send messages to LB 100 (and received by BD 120). A message is generated by forwarding complex 150 upon the completion of successful processing of each packet at an FE 110, informing BD 120 that a packet left the system. The message includes the packet's flow id (preferably using the four-tuple). In addition, BD 120 maintains flow table 180 which is indexed and searchable by flow ids. Each flow entered in table 180 has two fields associated with it: the index of the target FE 110, and the number of packets of the flow within the system.

FIG. 9 shows the steps carried out by BD 120 when making a forwarding decision. Upon the arrival of a packet, the packet's flow id is used to search table 180 for a valid entry (Step 1). If a valid entry is found, BD 120 returns the FE 110 field of the entry as the packet's target FE 110 (Steps 2 and 3). Otherwise, if there is room in the table 180, the index of the FE 110 that currently has the minimum load is returned (Steps 4 and 5). In addition, an entry is created for the flow where the FE field is the index of the minimum-loaded FE 110 and the number of packets in that flow is set to one. Note that if the flow table 180 is not large enough to hold the all the flows in transit, packet reordering may occur. If there is no space left in the flow table 180, BD 120 makes an invalid or null decision (Step 6) which is disregarded by selector 140 and the packet will be forwarded to FE 110 chosen by hash splitter 130. The larger flow table 180, the more effective LB 100, but larger tables will take longer to index packets and are more costly.

When load balancer 100 receives a message from forwarding complex 150 that a packet has been sent from an FE 100 to its destination, the packet entry is located in the flow table using the flow id provided in the message. The number of packets within the identified flow in the system is decremented by one. When the number of packets of a particular flow reaches zero, the entry is eliminated from the flow table to make room for other incoming flows.

Experiments were conducted to evaluate load balancer 100 as shown in FIG. 8, and particularly to compare the performance of the burst-level load balancer (BLB) disclosed herein with that of the flow-level balancer (FLB) known in the art.

In these experiments, the utilization ρ is fixed at 0.8. The buffer size (of the FEs) and flow table sizes were considered in two scheduling schemes. The flow table size (S_{F}) was varied for the FLB and simulated for the flow table's periodic triggering policy. In a preferred embodiment, the triggering policy is invoked periodically, i.e., triggered by a clock after every fixed period of time. This policy is easy to implement, as it does not require any load information from the system. However, alternates policies are also suitable. The window size (S_{W}) was set to 10000 and the system load-checking duration (S_{T}) was set to 20 time units.

Two output parameters were evaluated in the experiments, the number of packet reordering events and the number of lost packets. Packets in a flow were sequentially indexed. At the output port, each packet was checked to determine if it was in a sequence within its own flow. A counter was incremented by one whenever a packet's index was less than that of the last packet from the same flow.

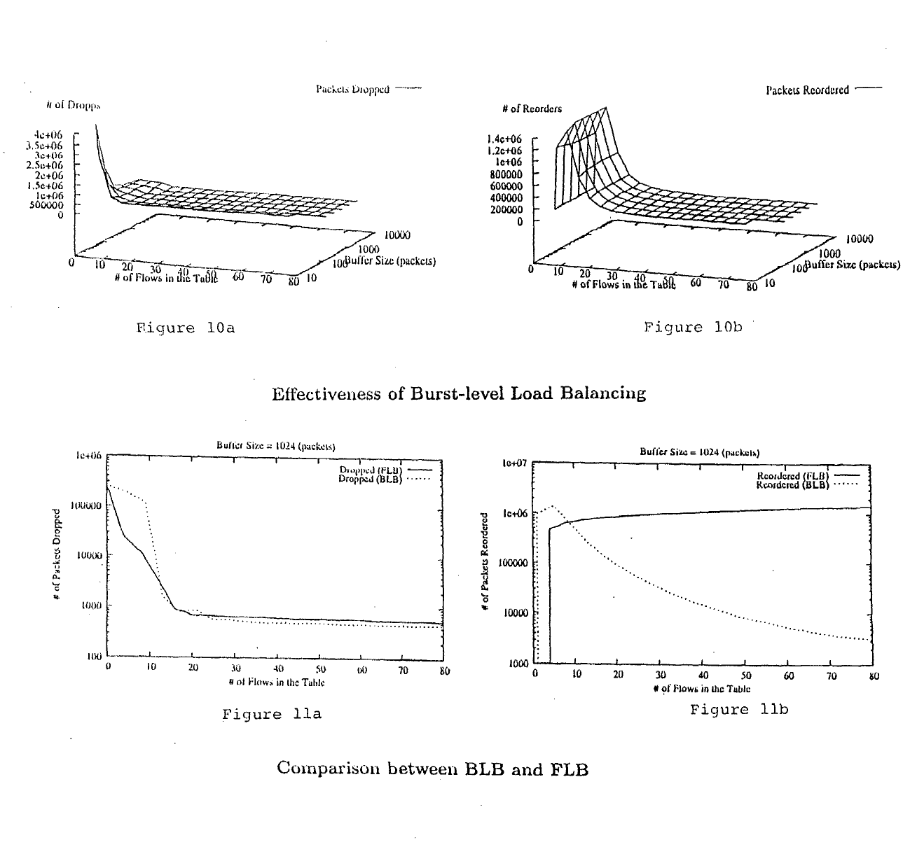

The simulation results were summarized in FIGS. 10a and 10b and FIGS. 11a and 11b. FIGS. 10a and 10b demonstrate that both packet dropping and reordering can be drastically reduced when several dozens of flows are installed in the burst distributor 120 flow table. Generally, when the flow table size is fixed, increasing the buffer size of the FEs reduces the rate of dropping packets but slightly increases the number of reordered packets. In addition, when the number of flows is small, the packet reordering rate increases sharply from zero when only hashing is used to distribute the packets.

The comparison with the flow-level load distributing scheme known in the art is shown in FIGS. 11a and 11b. The striking difference between the FLB and BLB schemes is that while both schemes reduce the dropped packet rates with increased flow table sizes, the FLB achieves this by sacrificing the reordering rates, while more flows in the BLB flow table result in both reduced dropping of packets and reduced reordering rates. In addition, when the flow table size is small (less than 10 as seen in FIGS. 10a and 10b and 11a and 11b), the BLB scheme is not as effective as the FLB in either reducing the dropping of packets or reordering packets. With larger flow table sizes, the BLB scheme performs much better than the FLB scheme.

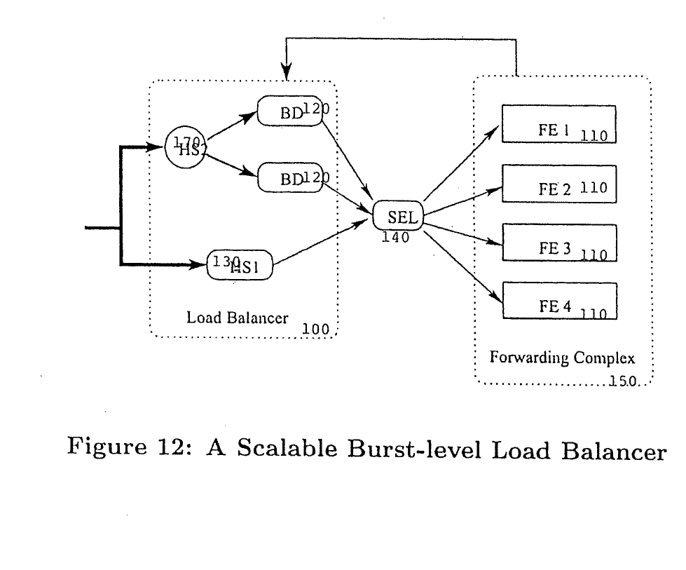

As shown in FIG. 12, in an alternative embodiment of the system according to the invention, the system can be scaled by adding a second hash splitter (HS2) 170 in front of additional BDs 120. As hashing is useful for spreading flows evenly, second hash splitter 170 evenly distributes the workload among the BDs 120. Messages from forwarding complex 150 to load balancer 100, target FEs as determined by the hashing results obtained from the pre-forwarding. For example, in a preferred implementation, each message contains a tag identifying the particular BD 120 that distributed the flow in the message. Note that each BD 120 can tag the packet for which it chooses the target FE 110, so that the messages from forwarding complex 150 can be augmented with the tags. A given BD 120 therefore need only parse the messages with the original tags it assigned.

BLB schemas as described herein should preserve temporal locality in the workload of given FEs 110. Assuming the gaps between bursts are large enough, shifting adjacent bursts in a flow onto different Fes 110 should not generate extraneous cache misses, as during the gaps the cache entry for the last packet in the first burst will be already aged out, and the first packet of the second burst will cause a cache miss in any case.

Although the particular preferred embodiments of the invention have been disclosed in detail for illustrative purposes, it will be recognized that variations or modifications of the disclosed apparatus lie within the scope of the present invention.

The invention claimed is:

1. A load balancer, comprising:
(a) a burst distributor,
(b) a hash splitter;
(c) a selector,
(d) a plurality of forwarding engines;
wherein said burst distributor receives a packet and selects one of said plurality of forwarding engines to transmit said packet, or selects an invalid forwarding engine to transmit said packet;
wherein said hash splitter also receives said packet; said hash splitter selects one of said plurality of forwarding engines to transmit said packet; and
wherein said selector receives said packet from said burst distributor and said hash splitter, and sends said packet to said forwarding engine selected by said burst distributor if said forwarding engine selected by said burst distributor is valid; and if said forwarding engine selected by said burst distributor is invalid, sending said packet to said forwarding engine selected by said hash splitter.

2. The load balancer of claim 1 wherein said burst distributor further comprises a flow table.

3. The load balancer of claim 2 wherein said burst distributor, on receipt of a packet, creates an entry in said flow table associated with said packet.

4. The load balancer of claim 3 wherein said entry in said flow table for said packet includes a flow associated with said packet.

5. The load balancer of claim 4 wherein said burst distributor, on transmitting said packet to said selector, tags said packet with information regarding said flow associated with said packet.

6. The load balancer of claim 5, wherein said forwarding engine selected by said selector, on transmitting said packet to a destination associated with said packet, transmits a message to said burst distributor.

7. The load balancer of claim 6 wherein, on receipt of said message from said forwarding engine selected by said selector, said burst distributor deletes said packet from said flow table.

8. The load balancer of claim 1 further comprising a second burst distributor, and a second hash splitter, wherein said second hash splitter determines which of said first and said second burst distributors receives said packet.

9. A method of balancing a flow of packets, comprising:
(a) a burst distributor and a hash splitter receiving a packet;
(b) said burst distributor selecting one of a plurality of forwarding engines to receive said packet, or selecting an invalid forwarding engine to receive said packet;
(c) said hash splitter selecting one of a plurality of forwarding engines to receive said packet;
(d) if said burst distributor selected one of said plurality of forwarding engines, sending said packet to said forwarding engines selected by said burst distributor; and
(e) if said burst distributor selected an invalid forwarding engine, sending said packet to said forwarding engine selected by said hash splitter.

10. The method of claim 9 wherein said burst distributor has a flow table.

11. The method of claim 10 further comprising: said burst distributor, on receipt of a packet, creating an entry in said flow table associated with said packet.

12. The method of claim 11 wherein said entry in said flow table for said packet includes a flow associated with said packet.

13. The load balancer of claim 12 further comprising: said burst distributor, on transmitting said packet to said forwarding engine selected by said load balancer, tagging said packet with information regarding said flow associated with said packet.

14. The load balancer of claim 13, further comprising: said selected forwarding engine, on transmitting said packet to a destination associated with said packet, transmitting a message to said burst distributor.

15. The load balancer of claim 14 further comprising: on receipt of said message from said selected forwarding engine, said burst distributor deleting said packet from said flow table.

16. A method of selecting a forwarding engine from a plurality of forwarding engines, comprising:
(a) providing a burst distributor having a flow table, said flow table having a plurality of records of packets, each of said packets associated with a flow, each of said flows associated with a forwarding engine;
(b) said burst distributor receiving a first packet, said first packet associated with a flow;
(c) searching said flow table for a second packet associated with said flow;
(d) if a second packet is located in said table, returning said forwarding engine associated with said flow that is associated with said second packet, to a selector;
(e) if said second packet is not located, determining if said flow table is full;
(f) if said flow table is not full, determining a forwarding engine within said plurality of forwarding engines having a minimum number of packets; and returning said forwarding engine having a minimum number of packets to said selector; and
(g) if said flow table is full, returning an invalid forwarding engine to said selector.
